(19) United States
(12) Patent Application Publication
(10) Pub. No.: US 2024/0265672 A1
(43) Pub. Date: Aug. 8, 2024

(54) IMAGE SIGNAL PROCESSOR AND METHOD FOR PROCESSING IMAGE SIGNAL

(71) Applicant: SK hynix Inc., Icheon-si Gyeonggi-do (KR)

(72) Inventors: Cheol Jon JANG, Icheon-si Gyeonggi-do (KR); Dong Ik KIM, Icheon-si Gyeonggi-do (KR); Jun Hyeok CHOI, Icheon-si Gyeonggi-do (KR)

(73) Assignee: SK hynix Inc., Icheon-si Gyeonggi-do (KR)

(21) Appl. No.: 18/396,255

(22) Filed: Dec. 26, 2023

(30) Foreign Application Priority Data
Feb. 8, 2023 (KR) 10-2023-0016512

(51) Int. Cl. G06V 10/75; G06T 7/13; G06V 10/56

(52) U.S. Cl. CPC G06V 10/751; G06T 7/13; G06V 10/56

(57) ABSTRACT

An image signal processor and an image signal processing method are disclosed. The image signal processor includes a half-edge pattern determination unit configured to determine whether a target kernel including a target pixel corresponds to a half-edge pattern, a half-edge pattern matching unit configured to determine directionality of the target kernel based on a half-edge pattern mask in which a highest weight is assigned to a pixel arranged in one direction from the target pixel when the target kernel corresponds to the half-edge pattern, and a pixel interpolation unit configured to interpolate the target pixel using pixel data of a pixel disposed at a position corresponding to the directionality of the target kernel, wherein the half-edge pattern is a pattern in which a region on one side of the edge crossing the kernel is filled with a texture region and a non-texture region.

### CROSS-REFERENCE TO RELATED APPLICATION

This patent document claims the priority and benefits of Korean patent application No. 10-2023-0016512, filed on Feb. 8, 2023, in the Korean Intellectual Property Office, the disclosure of which is incorporated herein by reference in its entirety as part of the disclosure of this patent document.

### TECHNICAL FIELD

The technology and implementations disclosed in this patent document generally relate to an image signal processor capable of performing processing required to improve the quality of images, and an image signal processing method using the same.

### BACKGROUND

An image sensing device is a device for capturing optical images by converting light into electrical signals by using a photosensitive semiconductor material that reacts to light. With the development of automotive, medical, computer, and communication industries, the demand for high-performance image sensing devices is increasing in various fields, such as smart phones, digital cameras, game machines, IoT (Internet of Things), robots, security cameras, and medical micro cameras.

A pixel array that directly captures an optical image in an image sensing device may include defective pixels that cannot normally acquire a color image due to process errors. In order to implement an autofocus function, phase difference detection pixel(s) may be included in the pixel array. The phase difference detection pixels capable of acquiring phase-difference related information cannot acquire color images in the same manner as defective pixels such that the phase difference detection pixels can be treated as defective pixels from the point of view of color images.

As a process for the pixel array advances and the autofocus function becomes more important, the ratio of defective pixels or phase difference detection pixels included in the pixel array increases, and the accuracy of correction for the detective pixels or the phase difference detection pixels is being highlighted as an important factor in determining the quality of images.

### SUMMARY

In accordance with an embodiment of the disclosed technology, an image signal processor may include a half-edge pattern determination unit configured to determine whether a target kernel including a target pixel corresponds to a half-edge pattern; a half-edge pattern matching unit configured to determine directionality of the target kernel based on a half-edge pattern mask in which a highest weight is assigned to a pixel arranged in one direction from the target pixel when the target kernel corresponds to the half-edge pattern; and a pixel interpolation unit configured to interpolate the target pixel using pixel data of a pixel disposed at a position corresponding to the directionality of the target kernel, wherein the half-edge pattern is a pattern in which a region on one side of the edge crossing the kernel is filled with a texture region and a non-texture region.

In accordance with another embodiment of the disclosed technology, an image signal processor may include: a half-edge pattern matching unit configured to determine directionality of a target kernel including a target pixel based on a half-edge pattern mask in which a highest weight is assigned to a pixel arranged in one direction from the target pixel; and a pixel interpolation unit configured to interpolate the target pixel using pixel data of a pixel disposed at a position corresponding to the directionality of the target kernel.

In accordance with another embodiment of the disclosed technology, an image signal processing method may include: determining directionality of a target kernel including a target pixel based on a half-edge pattern mask in which a highest weight is assigned to a pixel arranged in one direction from the target pixel; and interpolating the target pixel using pixel data of a pixel disposed at a position corresponding to the directionality of the target kernel.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an example of an image signal processor based on some implementations of the disclosed technology.

FIG. 2 is a block diagram illustrating an example of a defective pixel corrector shown in FIG. 1 based on some implementations of the disclosed technology.

FIGS. 3A to 3H are schematic diagrams illustrating examples of half-edge patterns based on some implementations of the disclosed technology.

FIG. 4 is a flowchart illustrating an example of operations of the defective pixel corrector shown in FIG. 2 based on some implementations of the disclosed technology.

FIG. 5 is a schematic diagram illustrating an example of operation S10 shown in FIG. 4 based on some implementations of the disclosed technology.

FIGS. 6A to 6D are schematic diagrams illustrating examples of operation S20 shown in FIG. 4 based on some implementations of the disclosed technology.

FIG. 7 is a schematic diagram illustrating an example of operation S30 shown in FIG. 4 based on some implementations of the disclosed technology.

FIG. 8 is a schematic diagram illustrating an example of operation S40 shown in FIG. 4 based on some implementations of the disclosed technology.

FIG. 9 is a diagram illustrating an example of a method for performing operation S40 according to the example shown in FIG. 8 based on some implementations of the disclosed technology.

### DETAILED DESCRIPTION

This patent document provides implementations and examples of an image signal processor capable of performing processing required for improving the quality of images that may be used in configurations to substantially address one or more technical or engineering issues and to mitigate limitations or disadvantages encountered in some other image signal processors. Some implementations of the disclosed technology relate to an image signal processor capable of increasing the accuracy of correction of defective pixels or the like, and an image signal processing method for the same. The disclosed technology provides various implementations of an image signal processor that can interpolate a target kernel by determining a half-edge pattern to be matched to the target kernel, so that the accuracy of correction of defective pixels can be increased even when the target kernel corresponds to the half-edge pattern.

Reference will now be made in detail to the embodiments of the disclosed technology, examples of which are illustrated in the accompanying drawings. Wherever possible, the same reference numbers will be used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

Hereafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

Various embodiments of the disclosed technology relate to an image signal processor capable of increasing the accuracy of correction of defective pixels or the like, and an image signal processing method for the same.

It is to be understood that both the foregoing general description and the following detailed description of the disclosed technology are illustrative and explanatory and are intended to provide further explanation of the disclosure as claimed.

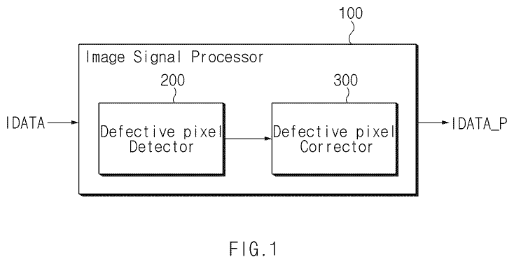

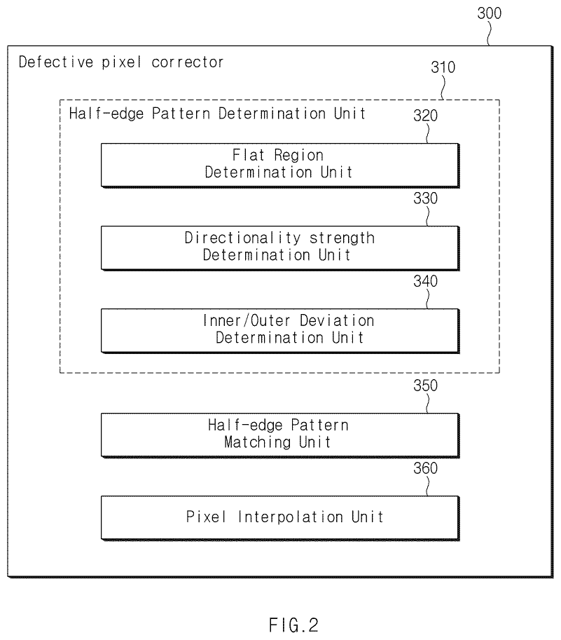

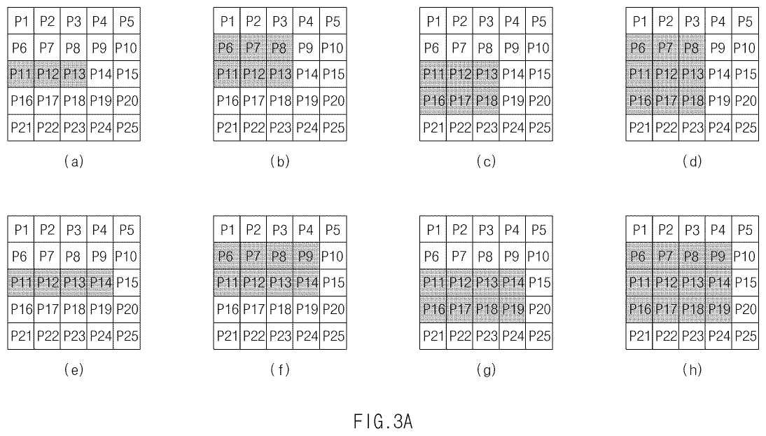

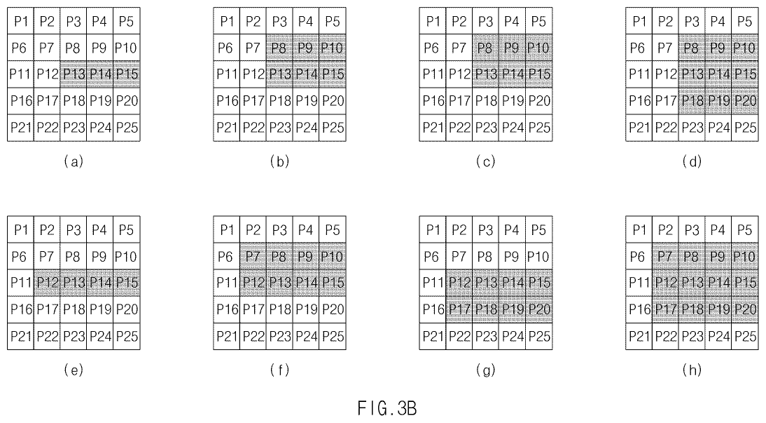

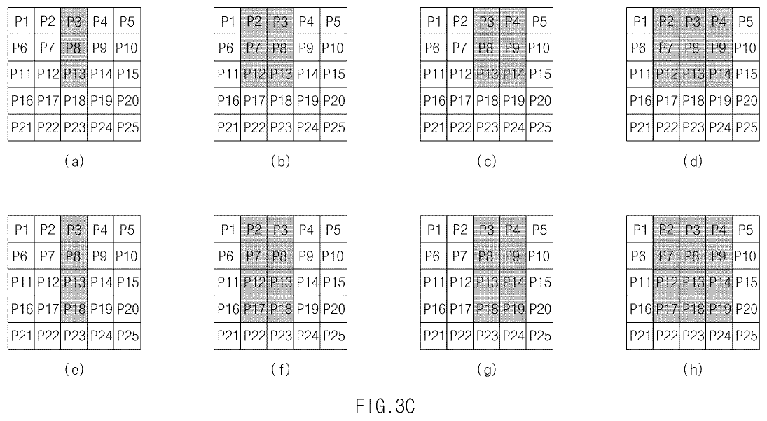

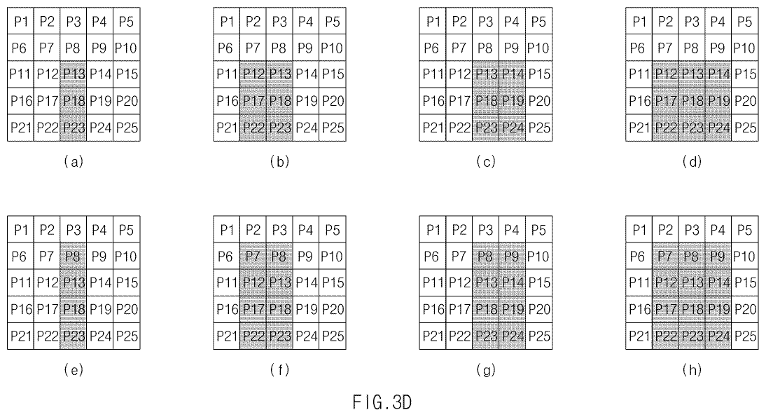

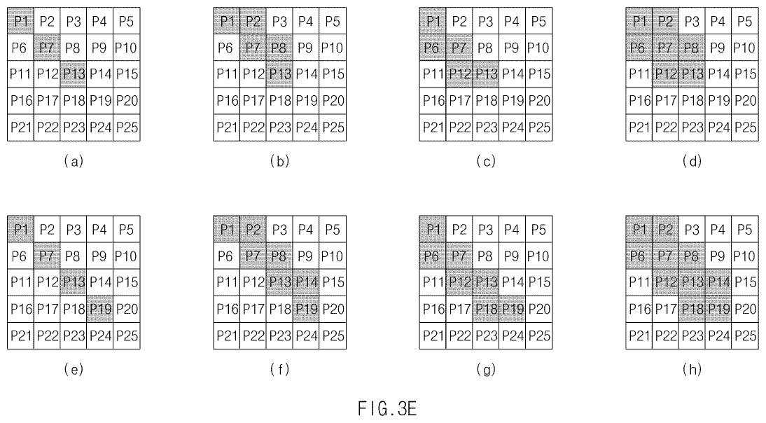

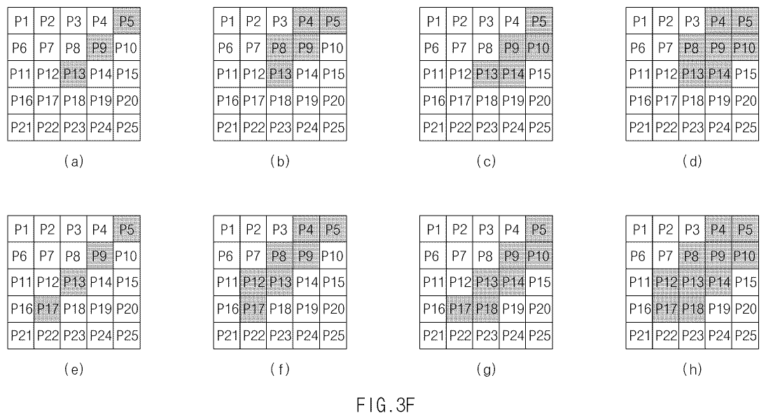

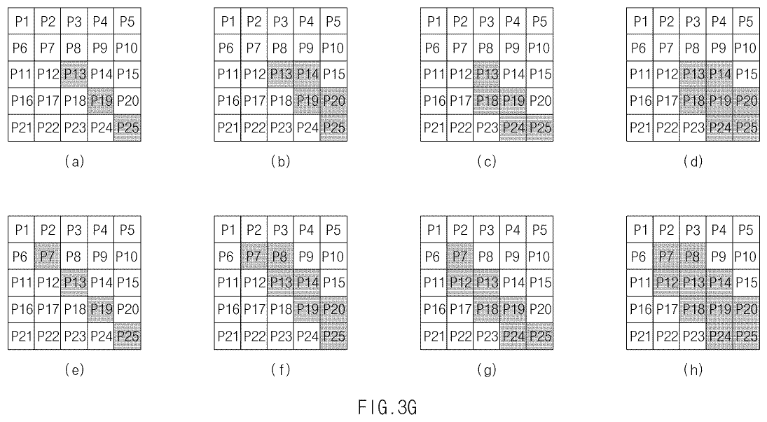

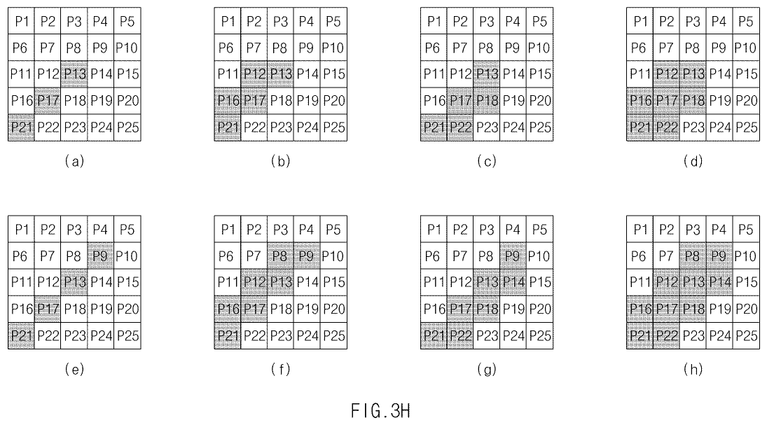

FIG. 1 is a block diagram illustrating an example of an image signal processor (ISP) 100 based on some implementations of the disclosed technology. FIG. 2 is a block diagram illustrating an example of a defective pixel corrector, shown in FIG. 1, based on some implementations of the disclosed technology. FIGS. 3A to 3H are schematic diagrams illustrating examples of half-edge patterns based on some implementations of the disclosed technology.

Referring to FIG. 1, the image signal processor (ISP) 100 may perform at least one image signal processing on image data (IDATA) to generate the processed image data (IDAT_AP). The image signal processor (ISP) 100 may reduce the noise of image data (IDATA) and may perform various kinds of image signal processing (e.g., demosaicing, defect pixel correction, gamma correction, color filter array interpolation, color matrix, color correction, color enhancement, lens distortion correction, etc.) for image-quality improvement of the image data. In addition, the ISP 100 may compress image data that has been created by executing image signal processing for image-quality improvement such that the ISP 100 can create an image file by using the compressed image data. Alternatively, the ISP 100 may recover image data from the image file. In this case, the scheme for compressing such image data may be a reversible format or an irreversible format. As a representative example of such compression format, in the case of using a still image, Joint Photographic Experts Group (JPEG) format, JPEG 2000 format, or the like can be used. In addition, in the case of using moving images, a plurality of frames can be compressed according to Moving Picture Experts Group (MPEG) standards such that moving image files can be created.

The image data (IDATA) may be generated by an image sensing device that captures an optical image of a scene, but the scope of the disclosed technology is not limited thereto. The image sensing device may include a pixel array including a plurality of pixels configured to sense incident light received from a scene, a control circuit configured to control the pixel array, and a readout circuit configured to output digital image data (IDATA) by converting an analog pixel signal received from the pixel array into the digital image data (IDATA). In some implementations of the disclosed technology, it is assumed that the image data (IDATA) is generated by the image sensing device.

The pixel array of the image sensing device may include defective pixels that cannot normally capture a color image due to process limitations or inflow of temporary noise. In addition, the pixel array may include phase difference detection pixels configured to acquire phase difference-related information to implement the autofocus function. The phase difference detection pixels cannot acquire color images in the same manner as defective pixels such that the phase difference detection pixels can be treated as defective pixels from the point of view of color images. In some implementations, for convenience of description and better understanding of the disclosed technology, the defective pixel and the phase difference detection pixel, each of which cannot normally acquire the color image, will hereinafter be collectively referred to as “defective pixels”.

In order to increase the quality of color images, it is essential to improve the accuracy in correcting defective pixels. To this end, the ISP 100, based on some implementations of the disclosed technology, may include a defective pixel detector 200 and a defective pixel corrector 300.

The defective pixel detector 200 may detect pixel data of the defective pixel from the image data (IDATA). In some implementations of the disclosed technology, for convenience of description, digital data corresponding to a pixel signal of each pixel will hereinafter be defined as pixel data, and a set of pixel data corresponding to a predetermined unit (e.g., a frame or kernel) will hereinafter be defined as image data (IDATA). Here, the frame may correspond to the entire pixel array, and the kernel may refer to a unit for image signal processing.

In some implementations, the defective pixel detector 200 may detect pixel data of the defective pixel based on the image data (IDATA). For example, the defective pixel detector 200 may calculate a difference between pixel data of a target pixel (to be used as a target for determining whether or not the corresponding pixel is a defective pixel) and an average value of pixel data belonging to a kernel and may determine whether the target pixel is a defective pixel based on the calculated difference. That is, the defective pixel detector 200 may determine that the target pixel is a defective pixel having no normal pixel data when a difference between the pixel data of the target pixel and the average value of pixel data belonging to the kernel is equal to or greater than a predetermined threshold value.

In some other implementations, the defective pixel detector 200 may receive pre-stored position information of defective pixels from the image sensing device that generates image data (IDATA) and may determine whether the target pixel is a defective pixel based on the position information of the defective pixels. The image sensing device may store position information of fixed defective pixels due to fabrication process reasons in an internal storage (e.g., one time programmable (OTP) memory) and may provide the position information of the defective pixels to the ISP 100.

When the target pixel is determined to be a defective pixel by the defective pixel detector 200, the defective pixel corrector 300 may correct pixel data of the target pixel based on image data of a kernel including the target pixel.

Referring to FIG. 2, the defective pixel corrector 300 may include a half-edge pattern determination unit 310, a half-edge pattern matching unit 350, and a pixel interpolation unit 360.

The half-edge pattern determination unit 310 may determine a half-edge pattern corresponding to a kernel including a target pixel.

Image data (IDATA) corresponding to one frame may include textures of various sizes and shapes. A texture may refer to a set of pixels having similarities, and for example, a subject (target object) having a unified color included in a scene may be recognized as a texture. A boundary of textures may be defined as an edge, and pixel data may vary greatly on the inside portion of the edge (inside of the texture) and on the outside portion of the edge (outside of the texture).

Typically, when a portion of the edge is included in a kernel, the edge may be formed in a straight line crossing the kernel, and pixels included in the kernel may be divided into two types of pixels centered on the edge. As such, a pattern in which pixels included in the kernel are divided into two types of pixels around the edge may be defined as a full-edge pattern. In this case, when the target pixel of the kernel is a defective pixel, the image signal processor may correct the target pixel based on pixel data of adjacent pixels disposed on one side, either inside or outside, of the edge.

An example of such half-edge pattern is depicted in each of FIGS. 3A to 3H. The half-edge pattern may refer to a pattern in which pixels included in a kernel are not divided into two types of pixels with respect to the edge while having directionality in the same manner as in the full-edge pattern. The half-edge pattern may be a pattern located at an end (e.g., corner) of the texture. In addition, the half-edge pattern may refer to a pattern in which a region on one side of the edge crossing the kernel is filled with a region corresponding to a texture (i.e., a texture region) and a region not corresponding to a texture (i.e., a non-texture region), rather than a pattern in which a region on one side of the edge is filled with the texture region and a region on the other side of the edge is filled with the non-texture region.

Meanwhile, in some implementations of the disclosed technology, it is assumed that the operations of detecting and correcting defective pixels by the ISP 100 are performed in units of a (5×5) kernel having 5 rows and 5 columns.

In each of FIGS. 3A to 3H, the first to twenty-fifth pixels (P1˜P25) may constitute a (5×5) kernel, and the thirteenth pixel P13 located at the center of the pixel array may correspond to a target pixel. In addition, each of shaded pixels may be a pixel having pixel data similar to those of the target pixel and may refer to a pixel constituting a half-edge pattern included in the same texture as the target pixel.

Here, the pixel data of the target pixel may refer to normal color pixel data that can be obtained when the target pixel is not a defective pixel.

Referring first to FIG. 3A, examples of half-edge patterns having a leftward directionality are illustrated in (a) to (h). As can be seen from (a) to (h) of FIG. 3A, various half-edge patterns are illustrated, each of which selectively further includes some pixels that are within a pixel-distance from the pixels P11 to P13, a pixel-distance being a length of one pixel. In more detail, each of the half-edge patterns may include a target pixel P13 and the eleventh to twelfth pixels P11 and P12. Here, the eleventh to twelfth pixels P11 and P12 are disposed in a left direction from the target pixel P13. Various half-edge patterns shown in (a) to (h) of FIG. 3A are disclosed only for illustrative purposes. As can be seen from the half-edge patterns shown in (a) to (h) of FIG. 3A, pixels that belong to the same texture as the target pixel in the same manner as the full-edge pattern while having leftward directionality, are not all disposed on one side of a straight edge.

FIG. 3B illustrates an example of half-edge patterns having a rightward directionality from the target pixel. FIG. 3C illustrates an example of half-edge patterns having an upward directionality from the target pixel. FIG. 3D illustrates an example of half-edge patterns having a downward directionality from the target pixel. FIG. 3E illustrates an example of half-edge patterns having a directionality in an upper-left direction from the target pixel. FIG. 3F illustrates an example of half-edge patterns having a directionality in an upper-right direction from the target pixel. FIG. 3G illustrates an example of half-edge patterns having a directionality in a lower-right direction from the target pixel. FIG. 3H illustrates an example of half-edge patterns having a directionality in a lower-left direction from the target pixel. The half-edge patterns, illustrated in FIGS. 3B to 3H, are disclosed only for illustrative purposes, and the scope or spirit of the disclosed technology is not limited thereto. The half-edge patterns shown in FIGS. 3B to 3H may have a directionality in the corresponding direction as described in FIG. 3A, and there may be various half-edge patterns in which pixels belonging to the same texture as the target pixel in the same manner as in the full-edge pattern are not all disposed on one side of the straight edge.

When determining directionality through a conventional edge determination method, it may be impossible for the half-edge patterns, shown in FIGS. 3A to 3H, to accurately determine directionality. This is because the half-edge patterns do not have a shape arranged on one side of a straight edge with respect to a specific edge of a straight line.

In addition, although the disclosed technology assumes that half-edge patterns have any one of eight directions in a (5×5) kernel for convenience of description, other implementations are also possible, and it should be noted that other half-edge patterns having more subdivided directions may also exist in a kernel larger than the (5×5) kernel as necessary. In addition, the method for correcting defective pixels based on some implementations of the disclosed technology may be substantially equally applied to such half-edge patterns having more subdivided directions.

Referring back to FIG. 2, the half-edge pattern determination unit 310 may include a flat region determination unit 320, a directionality strength determination unit 330, and an inner/outer deviation determination unit 340.

The flat region determination unit 320 may determine whether a target kernel centered on a target pixel that has been determined to be a defective pixel by the defective pixel detector 200 corresponds to a flat region.

When the target kernel does not correspond to the flat region, the directionality strength determination unit 330 may calculate the directionality strength of the target kernel and may determine the presence or absence of a direction having strong directionality strength.

When the directionality strength of the target kernel is not strong, the inner/outer deviation determination unit 340 may calculate an inner/outer deviation indicating a deviation between an average of pixel data of pixels located inside the target kernel and an average of pixel data of pixels located outside of the target kernel.

When the inner/outer deviation is less than a threshold deviation, the half-edge pattern matching unit 350 may determine a half-edge pattern mask to be matched with the target kernel from among the plurality of half-edge pattern masks based on pixel data of a target kernel and a plurality of half-edge pattern masks.

The pixel interpolation unit 360 may interpolate a target pixel using pixel data of pixels determined by the half-edge pattern determination unit 310.

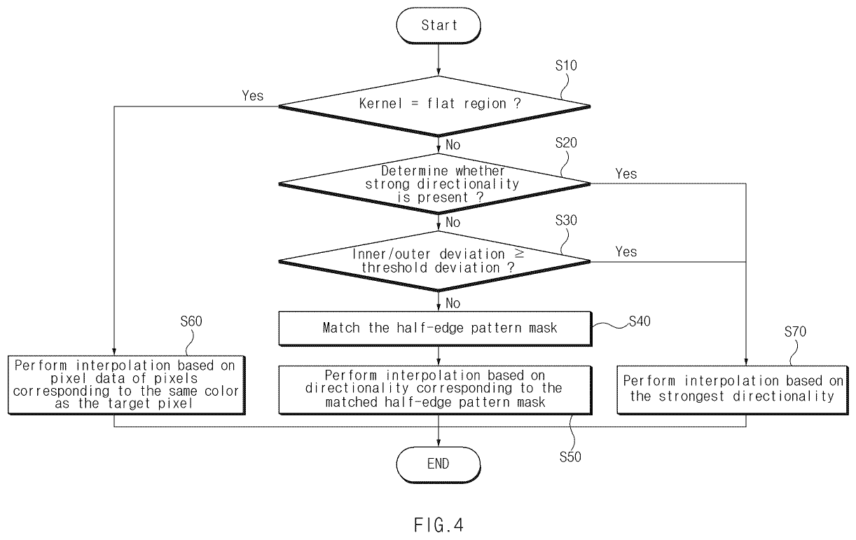

More detailed operations of the defective pixel corrector 300 will be described later with reference to FIG. 4.

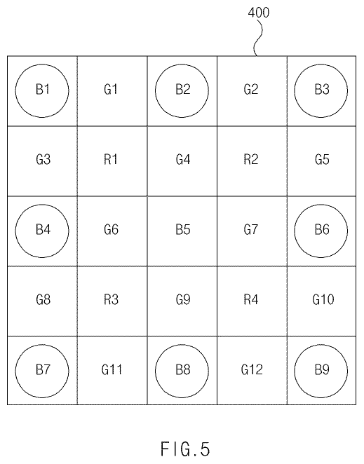

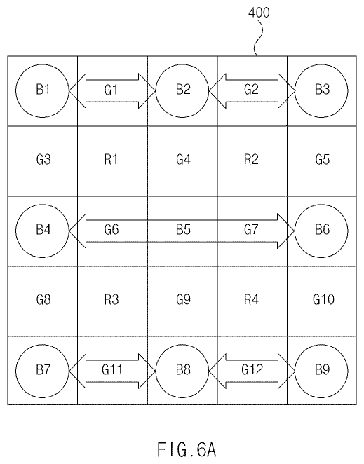

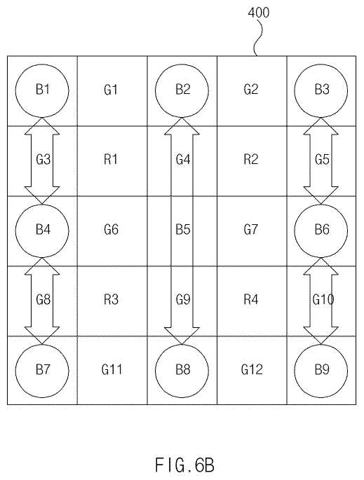

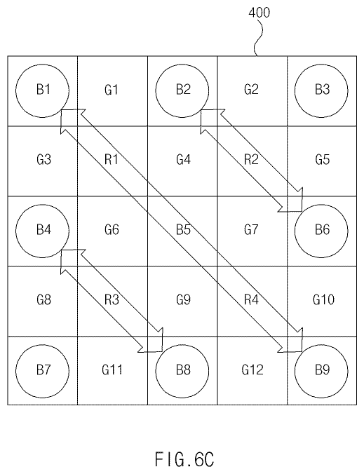

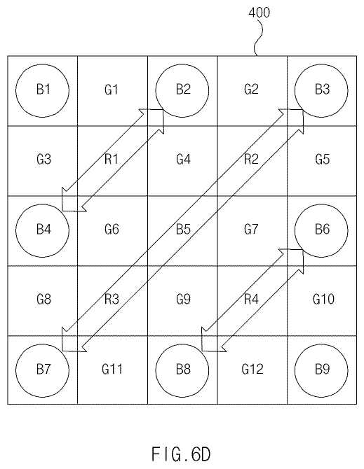

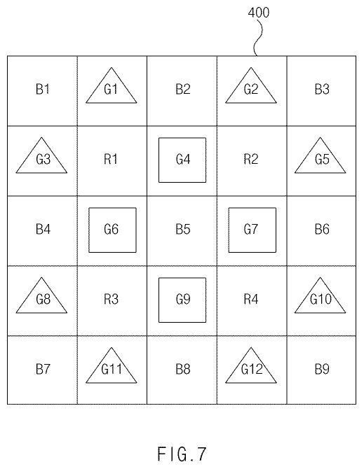

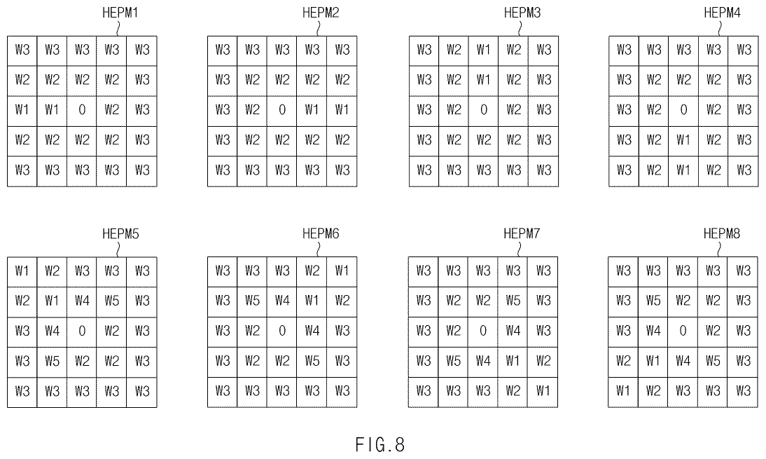

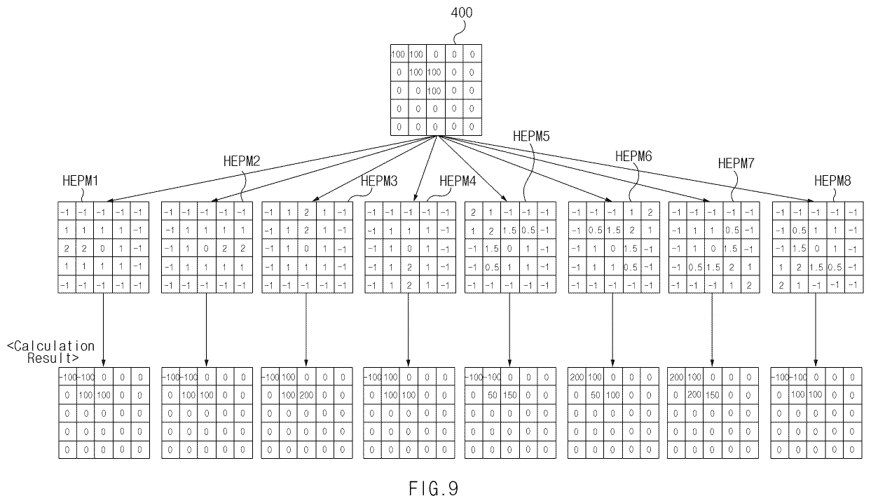

FIG. 4 is a flowchart illustrating an example of operations of the defective pixel corrector, shown in FIG. 2, based on some implementations of the disclosed technology. FIG. 5 is a schematic diagram illustrating an example of operation S10, shown in FIG. 4, based on some implementations of the disclosed technology. FIGS. 6A to 6D are schematic diagrams illustrating examples of operation S20, shown in FIG. 4, based on some implementations of the disclosed technology. FIG. 7 is a schematic diagram illustrating an example of operation S30, shown in FIG. 4, based on some implementations of the disclosed technology. FIG. 8 is a schematic diagram illustrating an example of operation S40, shown in FIG. 4, based on some implementations of the disclosed technology. FIG. 9 is a diagram illustrating an example of a method for performing operation S40 according to the example, shown in FIG. 8, based on some implementations of the disclosed technology.

Referring to FIG. 4, the defective pixel corrector 300 may determine whether predetermined conditions are satisfied for a target kernel including a target pixel to determine a type of the target kernel and may interpolate the target pixel using an interpolation method corresponding to the determined target kernel type.

As can be seen from FIGS. 4 to 9, examples of a method for correcting a defective pixel using a (5×5) kernel indicating a Bayer pattern as an example will hereinafter be described in detail. For example, the Bayer pattern may be a (5×5) kernel that includes blue pixels (B), red pixels (R), and green pixels (G), and a target pixel from among the (5×5) kernel may be the blue pixel (B). The red pixel (R) may generate red pixel data by detecting red light, the green pixel (G) may generate green pixel data by detecting green light, and the blue pixel (B) may generate blue pixel data by detecting blue light. In addition, it is assumed that each of the red pixel data, the green pixel data, and the blue pixel data has a range of 0 to 1023.

According to the embodiment of the disclosed technology, a kernel arranged in the Bayer pattern is described as an example, but the technical idea of the disclosed technology can also be applied to another kernel in which color pixels are arranged in other patterns, such as a quad-Bayer pattern, a nona-Bayer pattern, a hexa-Bayer pattern, an RGBW pattern, a mono pattern, and the like. In addition, a kernel having another size other than the (5×5) size may be used depending on performance of the ISP 100, required correction accuracy, an arrangement method of color pixels, and the like.

First, the flat region determination unit 320 may determine whether a target kernel in which a target pixel determined to be a defective pixel by the defective pixel detector 200 is disposed at the center of the kernel corresponds to a flat region (S10). The flat region may refer to a region in which the target kernel has similar pixel data, as a whole, without having specific directionality.

In FIG. 5, a (5×5) target kernel 400 in which the target pixel is the blue pixel B5 is illustrated. The flat region determination unit 320 may calculate a standard deviation of pixel data of blue pixels (B1˜B4, B6˜B9) corresponding to the same color as the blue pixel B5, may compare the calculated standard deviation with a predetermined threshold standard deviation and thus may determine whether the target kernel corresponds to a flat region based on the result of the comparison.

For example, if the standard deviation of the blue pixels (B1˜B4, B6˜B9) is less than or equal to a threshold standard deviation (e.g., 20), the flat region determination unit 320 may determine the target kernel 400 to be a flat region. Conversely, if the standard deviation of the blue pixels (B1˜B4, B6˜B9) exceeds a threshold standard deviation (e.g., 20), the flat region determination unit 320 may determine that the target kernel 400 is not a flat region.

When it is determined that the target kernel 400 corresponds to the flat region (‘Yes’ in Operation S10), the pixel interpolation unit 360 may interpolate the target pixel based on pixel data of pixels corresponding to the same color as the target pixel of the target kernel 400 (Operation S60). For example, the pixel interpolation unit 360 may determine an average value of the pixel data of the blue pixels (B1˜B4, B6˜B9) to be the pixel data of the target pixel.

When it is determined that the target kernel 400 does not correspond to the flat region ('No' in Operation S10), the directionality strength determination unit 330 may calculate the directionality strength of the target kernel and thus may determine the presence or absence of a direction having strong directionality strength based on the calculated directionality strength (Operation S20). In some implementations of the disclosed technology, the directionality strength may correspond to a sum of gradients (hereinafter referred to as a gradient sum) and may be a value that is obtained by summing the differences between pixel data values of pixels arranged in a specific direction within the target kernel 400.

Referring to FIG. 6A, the directionality strength determination unit 330 may calculate directionality strength corresponding to a first direction (e.g., a horizontal direction) in the target kernel 400. That is, the directionality strength determination unit 330 may calculate a sum of gradients (i.e., a gradient sum) in the first direction by summing the differences between pixel data values of blue pixel pairs arranged in the first direction. In more detail, the directionality strength determination unit 330 may calculate the sum of gradients (i.e., a gradient sum) in the first direction by summing a difference in pixel data between the blue pixels B1 and B2 serving as a pair of blue pixels (hereinafter referred to as a ‘blue pixel pair’), a difference in pixel data between the blue pixels B2 and B3 serving as a blue pixel pair, a difference in pixel data between the blue pixels B4 and B6, a difference in pixel data between the blue pixels B7 and B8 serving as a blue pixel pair, and a difference in pixel data between the blue pixels B8 and B9 serving as a blue pixel pair.

Referring to FIG. 6B, the directionality strength determination unit 330 may calculate directionality strength corresponding to a second direction (e.g., a vertical direction) in the target kernel 400. That is, the directionality strength determination unit 330 may calculate a sum of gradients (i.e., a gradient sum) in the second direction by summing the differences between pixel data values of blue pixel pairs arranged in the second direction. In more detail, the directionality strength determination unit 330 may calculate the sum of gradients (i.e., a gradient sum) in the second direction by summing a difference in pixel data between the blue pixels B1 and B4 serving as a blue pixel pair, a difference in pixel data between the blue pixels B4 and B7 serving as a blue pixel pair, a difference in pixel data between the blue pixels B2 and B8, a difference in pixel data between the blue pixels B3 and B6 serving as a blue pixel pair, and a difference in pixel data between the blue pixels B6 and B9 serving as a blue pixel pair.

Referring to FIG. 6C, the directionality strength determination unit 330 may calculate directionality strength corresponding to a third direction (e.g., a backslash direction ‘\’) in the target kernel 400. That is, the directionality strength determination unit 330 may calculate a sum of gradients (i.e., a gradient sum) in the third direction by summing the differences between pixel data values of blue pixel pairs arranged in the third direction. In more detail, the directionality strength determination unit 330 may calculate the sum of gradients (i.e., a gradient sum) in the third direction by summing a difference in pixel data between the blue pixels B1 and B9 serving as a blue pixel pair, a difference in pixel data between the blue pixels B4 and B8 serving as a blue pixel pair, and a difference in pixel data between the blue pixels B2 and B6.

Referring to FIG. 6D, the directionality strength determination unit 330 may calculate directionality strength corresponding to a fourth direction (e.g., a slash direction ‘/’) in the target kernel 400. That is, the directionality strength determination unit 330 may calculate a sum of gradients (i.e., a gradient sum) in the fourth direction by summing the differences between pixel data values of blue pixel pairs arranged in the fourth direction. In more detail, the directionality strength determination unit 330 may calculate the sum of gradients (i.e., a gradient sum) in the fourth direction by summing a difference in pixel data between the blue pixels B3 and B7 serving as a blue pixel pair, a difference in pixel data between the blue pixels B2 and B4 serving as a blue pixel pair, and a difference in pixel data between the blue pixels B6 and B8.

The gradient sum in each of the first to fourth directions (i.e., the horizontal direction, the vertical direction, the backslash direction, and the slash direction) may represent the directionality strength for each direction. The directionality strength determination unit 330 may compare the directionality strengths of the first to fourth directions with each other and thus may determine the presence or absence of the direction having strong directionality strength based on the result of comparison in directionality strength.

Specifically, when the directionality strength for a specific direction having the strongest directionality strength from among the directionality strengths for the above four directions (i.e., the first to fourth directions) is higher than the directionality strength for each of the remaining directions by a threshold strength or greater, the directionality strength determination unit 330 may determine the specific direction to be a direction having strong directionality strength. Conversely, when the directionality strength of a specific direction having the strongest directionality strength from among the directionality strengths for the first to fourth directions is not higher than the directionality strength for each of the remaining directions by a threshold strength or greater, the directionality strength determination unit 330 may determine there to be an absence of a direction having strong directionality strength.

When the directionality strength determination unit 330 determines that a specific direction has strong directionality strength (‘Yes’ in Operation S20), the pixel interpolation unit 360 may interpolate a target pixel based on a specific direction having strong directionality strength (Operation S70). This means that if there is a specific direction having strong directionality strength, the target kernel 400 can be regarded as a full-edge pattern so that the pixel interpolation unit 360 can interpolate the target pixel using pixel data of pixels disposed on one side of the edge corresponding to the specific direction.

When the directionality strength determination unit 330 determines that there is no direction having strong directionality strength (‘No’ in Operation S20), the inner/outer deviation determination unit 340 may calculate an inner/outer deviation indicating a deviation between an average of pixel data of pixels located inside the target kernel 400 and an average of pixel data of pixels located outside of the target kernel 400 and may compare the inner/outer deviation with a predetermined threshold deviation (Operation S30).

Referring to FIG. 7, the inner/outer deviation determination unit 340 may calculate an average (i.e., the inner average) of pixel data of green pixels G4, G6, G7, and G9 located inside the target kernel 400 and may calculate an average (i.e., the outer average) of pixel data of the green pixels G1, G2, G3, G5, G8, G10, G11, and G12 located outside of the target kernel 400. The green pixels G4, G6, G7, and G9 may be determined to be located inside the target kernel 400 due to being within a pixel-distance from the target pixel B5 while green pixels G1, G2, G3, G5, G8, G10, G11, and G12 may be determined to be located outside of the target kernel 400 due to being farther than a pixel-distance from the target pixel B5.

The inner/outer deviation determination unit 340 may calculate the inner/outer deviation by calculating the difference between the inner average and the outer average and may compare the inner/outer deviation with a threshold deviation (e.g., Operation S30). The reason why the inner and outer averages are calculated based on the green pixels is that, since the target kernel 400 is arranged in a Bayer pattern and the largest number of green pixels are distributed in the Bayer pattern, the green pixels can be evenly distributed within the inside and the outside of the target kernel 400. The type of pixels and criteria for inner and outer pixels, which are the basis for calculating the inner and outer averages, may vary depending on the size and arrangement of the target kernel 400.

When the inner/outer deviation is greater than or equal to a predetermined threshold deviation (‘Yes’ in Operation S30), the pixel interpolation unit 360 may interpolate a target pixel based on a specific direction determined to have the strongest directionality by the directionality strength determination unit 330 (Operation S70). This is because the target kernel 400 has characteristics in which the target kernel 400 is more similar to the full-edge pattern than the half-edge pattern when the inner/outer deviation is greater than or equal to a predetermined threshold deviation, the interpolation method being more appropriate to use for the full-edge pattern.

When the inner/outer deviation is less than a predetermined threshold deviation (‘No’ in Operation S30), the half-edge pattern matching unit 350 may determine a half-edge pattern mask to be matched with the target kernel 400 from among the plurality of half-edge pattern masks based on pixel data of the target kernel 400 and a plurality of half-edge pattern masks (Operation S40).

Referring to FIG. 8, a plurality of half-edge pattern masks HEPM1 to HEPM8 for operating with pixel data of the target kernel 400 are shown as an example. Each of the plurality of half-edge pattern masks HEPM1 to HEPM8 may have a shape of the (5×5) kernel corresponding to the target kernel 400 and may be a mask in which a corresponding weight is assigned to each pixel. Since the target pixel corresponds to a defective pixel, a weight corresponding to the target pixel may be set to zero ‘0’ in each of the plurality of half-edge pattern masks HEPM1 to HEPM8 so that pixel data of the target pixel may be excluded from subsequent calculations.

Each of the plurality of half-edge pattern masks HEPM1 to HEPM8 may be implemented as a filter configured such that the highest weight is assigned to at least one pixel disposed in a corresponding direction (e.g., the left direction in the half-edge pattern mask HEPM1). In addition, each of the plurality of half-edge pattern masks HEPM1 to HEPM8 may include a weight that is assigned to be lowered as the distance from the corresponding direction increases.

The first half-edge pattern mask HEPM1 may be implemented as a filter configured such that relatively high weights are assigned to pixels located in the left area of the target kernel 400. The first half-edge pattern mask HEPM1 may be implemented as a filter configured such that a first weight W1 is assigned to each position of pixels B4 and G6 disposed in the left direction from the target pixel B5, a second weight W2 is assigned to each position of pixels that are a pixel-distance from the pixels B5, B4, and G6 (G3, R1, G4, R2, G7, R4, G9, R3, G8), and a third weight W3 is assigned to each position of the remaining pixels (B1, G1, B2, G2, B3, G5, B6, G10, B9, G12, B8, G11, and B7).

The second half-edge pattern mask HEPM2 may be implemented as a filter configured such that relatively high weights are assigned to pixels located in the right area of the target kernel 400. The second half-edge pattern mask HEPM2 may be implemented as a filter configured such that a first weight W1 is assigned to each position of pixels G7 and B6 disposed in the right direction from the target pixel B5, a second weight W2 is assigned to each position of pixels that are a pixel-distance from the pixels B5, G7, and B6 (G5, R2, G4, R1, G6, R3, G9, R4, G10), and a third weight W3 is assigned to each position of the remaining pixels (B3, G2, B2, G1, B1, G3, B4, G8, B7, G11, B8, G12, and B9).

The third half-edge pattern mask HEPM3 may be implemented as a filter configured such that relatively high weights are assigned to pixels located in the upper area of the target kernel 400. The third half-edge pattern mask HEPM3 may be implemented as a filter configured such that a first weight W1 is assigned to each position of pixels G4 and B2 disposed in an upward direction from the target pixel B5, a second weight W2 is assigned to each position of pixels that are a pixel-distance from the pixels B5, G4, B2 (G1, R1, G6, R3, G9, R4, G7, R2, G2), and a third weight W3 is assigned to each position of the remaining pixels (B1, G3, B4, G8, B7, G11, B8, G12, B9, G10, B6, G5, and B3).

The fourth half-edge pattern mask HEPM4 may be implemented as a filter configured such that relatively high weights are assigned to pixels located in the lower area of the target kernel 400. The fourth half-edge pattern mask HEPM4 may be implemented as a filter configured such that a first weight W1 is assigned to each position of pixels G9 and B8 disposed in a downward direction from the target pixel B5, a second weight W2 is assigned to each position of pixels that are a pixel-distance from the pixels B5, G9, and B8 (G11, R3, G6, R1, G4, R2, G7, R4, G12), and a third weight W3 is assigned to each position of the remaining pixels (B7, G8, B4, G3, B1, G1, B2, G2, B3, G5, B6, G10, and B9).

The fifth half-edge pattern mask HEPM5 may be implemented as a filter configured such that relatively high weights are assigned to pixels located in the upper-left area of the target kernel 400. The fifth half-edge pattern mask HEPM5 may be implemented as a filter configured such that a first weight W1 is assigned to each position of pixels (R1, B1) disposed in the upper-left direction from the target pixel B5, the second, fourth, or fifth weight W2, W4 or W5 is assigned to each position of pixels that are a pixel-distance from the pixels B5, R1, and B1 (G1, G3, G4, G6, R2, R3, G7, G9, R4), except for pixels B2 and B4, and a third weight W3 is assigned to each position of the remaining pixels (B2, G2, B3, G5, B6, G10, B9, G12, B8, G11, B7, G8, and B4).

The sixth half-edge pattern mask HEPM6 may be implemented as a filter configured such that relatively high weights are assigned to pixels located in the upper-right area of the target kernel 400. The sixth half-edge pattern mask HEPM6 may be implemented as a filter configured such that a first weight W1 is assigned to each position of pixels (R2, B3) disposed in the upper-right direction from the target pixel B5, the second, fourth, or fifth weight W2, W4 or W5 is assigned to each position of pixels that are a pixel-distance from the pixels B5, R2, and B3 (G2, G5, G4, G7, R1, R4, G6, G9, R3), except for pixels B2 and B6, and a third weight W3 is assigned to each position of the remaining pixels (B2, G1, B1, G3, B4, G8, B7, G11, B8, G12, B9, G10, and B6).

The seventh half-edge pattern mask HEPM7 may be implemented as a filter configured such that relatively high weights are assigned to pixels located in the lower-right area of the target kernel 400. The seventh half-edge pattern mask HEPM7 may be implemented as a filter configured such that a first weight W1 is assigned to each position of pixels (R4, B9) disposed in the lower-right direction from the target pixel B5, the second, fourth, or fifth weight W2, W4 or W5 is assigned to each position of pixels that are a pixel-distance from the pixels B5, R4, and B9 (G10, G12, G7, G9, R2, R3, G4, G6, R1), except for pixels B6 and B8, and a third weight W3 is assigned to each position of the remaining pixels (B6, G5, B3, G2, B2, G1, B1, G3, B4, G8, B7, G11, and B8).

The eighth half-edge pattern mask HEPM8 may be implemented as a filter configured such that relatively high weights are assigned to pixels located in the lower-left area of the target kernel 400. The eighth half-edge pattern mask HEPM8 may be implemented as a filter configured such that a first weight W1 is assigned to each position of pixels (R3, B7) disposed in the lower-left direction from the target pixel B5, the second, fourth, or fifth weight W2, W4 or W5 is assigned to each position of pixels that are a pixel-distance from the pixels B5, R3, and B7 (G8, G11, G6, G9, R1, R4, G4, G7, R2), except for pixels B4 and B8, and a third weight W3 is assigned to each position of the remaining pixels (B4, G3, B1, G1, B2, G2, B3, G5, B6, G10, B9, G12, and B8).

Referring to FIG. 8, the first weight W1 may be the highest weight, the third weight W3 may be the lowest weight, and the second weight W2 may be lower than the first weight W1 and higher than the third weight W3. In addition, the fourth weight W4 may be lower than the first weight W1 and higher than the second weight W2, and the fifth weight W5 may be lower than the second weight W2 and higher than the third weight W3.

A method for assigning weights included in the first to eighth half-edge pattern masks HEPM1 to HEPM8 is disclosed only for illustrative purposes and may be modified in various ways so long as relatively high weights are assigned to pixels arranged in the corresponding direction within the target kernel 400.

In some implementations, a pixel corresponding to the same color as the target pixel may be assigned a higher weight than a pixel corresponding to a different color from the target pixel under the same condition. Since the pixel corresponding to the same color as the target pixel has a high degree of similarity with the target pixel in terms of pixel data, assigning a relatively high weight to the pixel corresponding to the same color as the target pixel may help to increase the accuracy of directionality determination.

FIG. 9 illustrates an example in which the half-edge pattern matching unit 350 determines a half-edge pattern mask to be matched with the target kernel 400 from among the plurality of half-edge pattern masks HEPM1 to HEPM8 based on pixel data of the target kernel 400 and the plurality of half-edge pattern masks HEPM1 to HEPM8.

In the exemplary target kernel 400, shown in FIG. 9, it is assumed that, when the target pixel B5 is not a defective pixel, each of some pixels (B1, G1, R1, G4) arranged in the left-upper direction has pixel data of 100 and each of the remaining pixels has pixel data of 0.

In the half-edge pattern masks HEPM1 to HEPM8, the first weight W1 may be set to ‘2’, the second weight W2 may be set to ‘1’, the third weight W3 may be set to ‘−1’, the fourth weight W4 may be set to ‘1.5’, and the fifth weight W5 may be set to ‘0.5’.

The half-edge pattern matching unit 350 may perform weight calculation on the target kernel 400 and each of the half-edge pattern masks HEPM1 to HEPM8. The weight calculation may refer to an operation of multiplying pixel data of each pixel of the target kernel 400 and the weight of each pixel of each half-edge pattern mask (HEPM1˜HEPM8) on a basis of pixels corresponding to each other.

FIG. 9 illustrates the result of performing weight calculation on the target kernel 400 and each of the half-edge pattern masks HEPM1 to HEPM8, and the half-edge pattern matching unit 350 may sum up the results of such weight calculation for each half-edge pattern mask HEPM1 to HEPM8.

The results of the summation corresponding to each of the half-edge pattern masks HEPM1 to HEPM8 may be 0, 0, 300, 0, 650, 0, 0, and 50, respectively. In more detail, the result of the summation corresponding to the half-edge pattern mask HEPM1 may be 0, the result of the summation corresponding to the half-edge pattern mask HEPM2 may be 0, the result of the summation corresponding to the half-edge pattern mask HEPM3 may be 300, the result of the summation corresponding to the half-edge pattern mask HEPM4 may be 0, the result of the summation corresponding to the half-edge pattern mask HEPM5 may be 650, the result of the summation corresponding to the half-edge pattern mask HEPM6 may be 0, the result of the summation corresponding to the half-edge pattern mask HEPM7 may be 0, and the result of the summation corresponding to the half-edge pattern mask HEPM8 may be 50.

Each of the half-edge pattern masks HEPM1 to HEPM8 may correspond to a filter in which relatively high weights are assigned to pixels arranged in eight directions centered on the target pixel. Accordingly, if weight calculation between the target kernel 400 and each of the half-edge pattern masks HEPM1 to HEPM8 is performed and the result of summation is used, it is possible to determine which directionality is associated with the target kernel 400.

The half-edge pattern matching unit 350 may determine the left-upper direction corresponding to the fifth half-edge pattern mask HEPM5 having the highest summation result in the above example to be the directionality of the target kernel 400.

The pixel interpolation unit 360 may interpolate the target pixel using pixel data of pixels (e.g., B1, R1, G1, G3, G4, G6) corresponding to the directionality determined by the half-edge pattern determination unit 310 (Operation S50).

It may be difficult to accurately determine the directionality of half-edge patterns when determining the directionality through a method (e.g., a method for determining directionality using only the comparison of gradient sums) other than the method according to the disclosed technology. For example, when using another method for the target kernel 400 illustrated in FIG. 9, there might not be a significant difference in the gradient sum in the horizontal direction, the vertical direction, or the backslash direction, and the gradient sum in the backslash direction might not be calculated as the highest value.

In the disclosed technology, when the target kernel 400 corresponds to the half-edge pattern through the operations (S10˜S30) of determining a plurality of conditions considering characteristics of the half-edge pattern (that does not correspond to the flat region, does not have very strong directionality, and has a relatively small inner/outer deviation), the image signal processor may interpolate the target pixel by determining a half-edge pattern to be matched with the target kernel 400 so that the defective pixels can be accurately corrected even when the target kernel 400 corresponds to a half-edge pattern.

As is apparent from the above description, the image signal processor and the image signal processing method based on some implementations of the disclosed technology can interpolate a target kernel by determining a half-edge pattern to be matched to the target kernel, so that the accuracy of correction of defective pixels can be increased even when the target kernel corresponds to the half-edge pattern.

The embodiments of the disclosed technology may provide a variety of effects capable of being directly or indirectly recognized through the above-mentioned patent document.

Although a number of illustrative embodiments have been described, it should be understood that modifications and enhancements to the disclosed embodiments and other embodiments can be devised based on what is described and/or illustrated in this patent document.

What is claimed is:

1. An image signal processor comprising:
a half-edge pattern determination unit configured to determine whether a target kernel including a target pixel corresponds to a half-edge pattern;
a half-edge pattern matching unit configured to determine directionality of the target kernel based on a half-edge pattern mask in which a highest weight is assigned to a pixel arranged in one direction from the target pixel when the target kernel corresponds to the half-edge pattern; and
a pixel interpolation unit configured to interpolate the target pixel using pixel data of a pixel disposed at a position corresponding to the directionality of the target kernel,
wherein the half-edge pattern is a pattern in which a region on one side of the edge crossing the target kernel is filled with a texture region and a non-texture region.

2. The image signal processor according to claim 1, wherein the half-edge pattern determination unit includes:
a flat region determination unit configured to compare a standard deviation of pixel data of pixels included in the target kernel with a threshold standard deviation and determine whether the target kernel corresponds to a flat region.

3. The image signal processor according to claim 2, wherein, when the target kernel corresponds to the flat region, the pixel interpolation unit is configured to interpolate the target pixel based on pixel data of pixels corresponding to the same color as the target pixel.

4. The image signal processor according to claim 1, wherein the half-edge pattern determination unit includes:
a directionality strength determination unit configured to calculate directionality strength in each direction of the target kernel, compare a strongest directionality strength from among the directionality strengths in the respective directions of the target kernel with the remaining directionality strengths other than the strongest directionality strength, and determine whether a direction having strong directionality strength is present.

5. The image signal processor according to claim 4, wherein:
when the direction having the strong directional strength is present, the pixel interpolation unit is configured to interpolate the target pixel based on pixel data of a pixel disposed on one side of an edge corresponding to the direction having strong directionality strength.

6. The image signal processor according to claim 4, wherein:
the directionality strength for each direction is a value obtained by summing differences between pixel data of pixel pairs arranged in each direction.

7. The image signal processor according to claim 4, wherein the half-edge pattern determination unit includes:
an inner/outer deviation determination unit configured to calculate an inner/outer deviation indicating a difference between an average of pixel data of pixels located inside the target kernel and an average of pixel data of pixels located outside of the target kernel and configured to compare the inner/outer deviation with a predetermined threshold deviation.

8. The image signal processor according to claim 7, wherein:
when the inner/outer deviation is equal to or greater than the threshold deviation, the pixel interpolation unit is configured to interpolate the target pixel based on pixel data of a pixel disposed on one side of an edge corresponding to a direction having strong directionality strength.

9. The image signal processor according to claim 1, wherein:
the half-edge pattern determination unit is configured to determine whether the target kernel corresponds to the half-edge pattern based on pixel data of pixels corresponding to the same color as the target pixel in the target kernel.

10. The image signal processor according to claim 1, wherein the half-edge pattern mask includes a weight that is assigned based on the pixel's distance from the one direction, and
wherein the half-edge pattern mask assigns a lower weight as the pixel's distance from the one direction increases.

11. The image signal processor according to claim 1, wherein:
a weight corresponding to the target pixel in the half-edge pattern mask is zero ‘0’.

12. The image signal processor according to claim 1, wherein the half-edge pattern matching unit is configured to:
perform an operation of multiplying pixel data of each pixel of the target kernel and a weight of each pixel of the half-edge pattern mask on a basis of pixels corresponding to each other and perform a summation of resultant values of the multiplication operation; and
determine a direction corresponding to a half-edge pattern mask having a highest summation resultant value to be a directionality of the target kernel.

13. The image signal processor according to claim 1, wherein:
the one direction is any one of a left direction, a right direction, an upward direction, a downward direction, a upper-left direction, a upper-right direction, a lower-right direction, and a lower-left direction.

14. An image signal processor comprising:
a half-edge pattern matching unit configured to determine directionality of a target kernel including a target pixel based on a half-edge pattern mask in which a highest weight is assigned to a pixel arranged in one direction from the target pixel; and
a pixel interpolation unit configured to interpolate the target pixel using pixel data of a pixel disposed at a position corresponding to the directionality of the target kernel.

15. An image signal processing method comprising:
determining directionality of a target kernel including a target pixel based on a half-edge pattern mask in which a highest weight is assigned to a pixel arranged in one direction from the target pixel; and
interpolating the target pixel using pixel data of a pixel disposed at a position corresponding to the directionality of the target kernel.

16. The image signal processing method according to claim 15, further comprising:
prior to determining directionality of the target kernel, determining whether the target kernel corresponds to a half-edge pattern.

17. The image signal processing method according to claim 16, wherein the determining of whether the target kernel corresponds to the half-edge pattern includes comparing a standard deviation of pixel data of pixels included in the target kernel with a threshold standard deviation and determining whether the target kernel corresponds to a flat region, and
wherein, when the target kernel corresponds to the flat region, the interpolating of the target pixel includes interpolating the target pixel based on pixel data of pixels corresponding to the same color as the target pixel.

18. The image signal processing method according to claim 16, wherein the determining of whether the target kernel corresponds to the half-edge pattern includes comparing a strongest directionality strength from among directionality strengths in respective directions of the target kernel with the remaining directionality strengths other than the strongest directionality strength and determining whether a direction having strong directionality strength is present, and
wherein, when the direction having strong directionality strength is present, the interpolating of the target pixel includes interpolating the target pixel based on pixel data of a pixel disposed on one side of an edge corresponding to the direction having strong directionality strength.

19. The image signal processing method according to claim 16, wherein the determining of whether the target kernel corresponds to the half-edge pattern includes calculating an inner/outer deviation indicating a difference between an average of pixel data of pixels located inside the target kernel and an average of pixel data of pixels located outside of the target kernel and comparing the inner/outer deviation with a predetermined threshold deviation, and
wherein, when the inner/outer deviation is equal to or greater than the threshold deviation, the interpolating of the target pixel includes interpolating the target pixel based on pixel data of a pixel disposed on one side of an edge corresponding to a direction having strong directionality strength.

20. The image signal processing method according to claim 15, wherein the determining of the directionality of the target kernel includes:
performing an operation of multiplying pixel data of each pixel of the target kernel and a weight of each pixel of the half-edge pattern mask on a basis of pixels corresponding to each other and performing a summation of resultant values of the multiplication operation; and
determining a direction corresponding to a half-edge pattern mask having a highest summation resultant value to be a directionality of the target kernel.
